(19) United States
(12) Patent Application Publication
(10) Pub. No.: US 2025/0369536 A1
(43) Pub. Date: Dec. 4, 2025

(54) TRUSS ROD RATCHETING CLAMP

(71) Applicant: Nelson Irrigation Corporation, Walla Walla, WA (US)

(72) Inventors: Tanner R. DRUFFEL, Walla Walla, WA (US); Craig B. NELSON, Walla Walla, WA (US); Andrew B. HELLIE, Walla Walla, WA (US)

(21) Appl. No.: 19/221,300

(22) Filed: May 28, 2025

Related U.S. Application Data
(60) Provisional application No. 63/655,357, filed on Jun. 3, 2024.

(51) Int. Cl. F16L 3/10; A01G 25/09

(52) U.S. Cl. CPC F16L 3/1091; A01G 25/092

(57) ABSTRACT

A drop hose clamp secures a drop hose to a truss rod in a center pivot irrigation system. The drop hose clamp includes a truss rod connector with a rod channel that is configured to receive the truss rod, a drop hose wear guard positioned above the rod channel, a connecting axle on one side of the rod channel, and ratchet channels on an opposite side of the rod channel. The clamp also includes a securing connector engageable with the truss rod connector and having pivot arms engageable with the connecting axle, a drop hose channel, and ratchet arms respectively engageable with the ratchet channels.

### CROSS-REFERENCES TO RELATED APPLICATIONS

This application claims the benefit of U.S. Provisional Patent Application Ser. No. 63/655,357, filed Jun. 3, 2024, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a drop hose clamp for a center pivot irrigation system and, more particularly, to a drop hose clamp that secures the drop hose against a truss rod.

The drop hose clamp is designed specifically for drop hose irrigation. With reference to FIG. 12, this style of irrigation involves a long span pipe 101, which transports irrigation water along the span. Supporting the pipe 101 are truss rods 103. There are many truss rods 103 in the span that create this support for the pipe 101 and the water it carries. The truss rods 103 are used to rest drop hoses 105, thus creating a greater distance between hoses 105 on opposite sides of the span pipe 101.

It is desirable to secure the drop hose against the truss rod to reduce the risk of drop hoses tangling in the wind or around the truss rod itself.

An exemplary drop hose clamp is shown in FIG. 12 and is described in U.S. Published Application 2023/0383867, the content of which is hereby incorporated by reference. The described design can be difficult to secure against the truss rod. Additionally, the zip ties used with the prior drop hose clamp do not provide enough security for the connection, and wire ties can undesirably scar the truss rod.

### SUMMARY

The drop hose clamp of the described embodiments secures the drop hose in place against the truss rod and overcomes drawbacks of the prior design. In use, drop hoses can get caught on objects closer to the ground, which results in pulling forces on the drop hose toward the ground. The drop hose clamp also prevents kinking of the hoses and keeps the hose from wearing against the galvanized truss rod.

In an exemplary embodiment, a drop hose clamp for securing a drop hose to a truss rod in a center pivot irrigation system includes a truss rod connector with a rod channel that is configured to receive the truss rod, a drop hose wear guard positioned above the rod channel, a connecting axle on one side of the rod channel, and ratchet channels on an opposite side of the rod channel. A securing connector engageable with the truss rod connector includes pivot arms engageable with the connecting axle, a drop hose channel, and ratchet arms respectively engageable with the ratchet channels.

The rod channel may include ridges. The rod channel may be V-shaped.

The drop hose wear guard may include a curved lower surface that is shaped to engage the truss rod. The drop hose wear guard may define a channel in an upper surface that is shaped to receive the drop hose. The drop hose wear guard may be configured to be manually displaceable away from the rod channel. In this context, the drop hose wear guard may be connected to the truss rod connector via a living hinge.

The truss rod connector further may include a tool ledge positioned between the ratchet arms.

In some embodiments, when the securing connector is coupled with the truss rod connector, the drop hose may be sandwiched between the drop hose channel and the drop hose wear guard.

The ratchet channels may include a pawl that is configured to engage the ratchet arms. A finger tab extending from the pawl may be configured to enable manual release of the pawl from the ratchet arms.

Each of the pivot arms may be connected via a bridge to each of the ratchet arms, where the pivot arms, the bridges, and the ratchet arms define a lower channel for receiving the truss rod. The securing connector may further include a connecting arch that connects the pivot arm and ratchet arm on one side of the securing connector with the pivot arm and ratchet arm on an opposite side of the securing connector, where the connecting arch defines the drop hose channel.

In another exemplary embodiment, a drop hose clamp for securing a drop hose to a truss rod in a center pivot irrigation system includes a truss rod connector including a rod channel and a drop hose wear guard positioned above the rod channel. The truss rod connector includes a pivot end and a connecting end. A securing connector engageable with the truss rod connector includes pivot arms engageable with the pivot end of the truss rod connector, and ratchet arms securable to the connecting end of the truss rod connector.

In yet another exemplary embodiment, a method of securing a drop hose to a truss rod in a center pivot irrigation system with a drop hose clamp includes the steps of (a) positioning the truss rod connector on the truss rod with the truss rod in the rod channel and the drop hose wear guard positioned over the truss rod; (b) setting the drop hose over the drop hose wear guard; (c) positioning the securing connector for engagement with the truss rod connector; (d) engaging the pivot arms with the connecting axle; and (e) pivoting the securing connector to insert the ratchet arms into the ratchet channels until the truss rod and the drop hose are secured under the securing connector. Step (a) may be practiced by manually displacing the drop hose wear guard so that the truss rod can fit in a space between the drop hose wear guard and the rod channel.

### BRIEF DESCRIPTION OF THE DRAWINGS

These and other aspects and advantages will be described in detail with reference to the accompanying drawings, in which:

FIGS. 1 and 2 show a truss rod connector of the drop hose clamp;

FIG. 3 is a sectional view of the truss rod connector without the drop hose wear guard;

FIGS. 4 and 5 show the securing connector of the drop hose clamp;

FIGS. 6-10 show the connection of the drop hose clamp to a truss rod and drop hose;

FIG. 11 is a sectional view of the drop hose clamp in an assembled and connected configuration; and

FIG. 12 shows a center pivot irrigation system.

### DETAILED DESCRIPTION

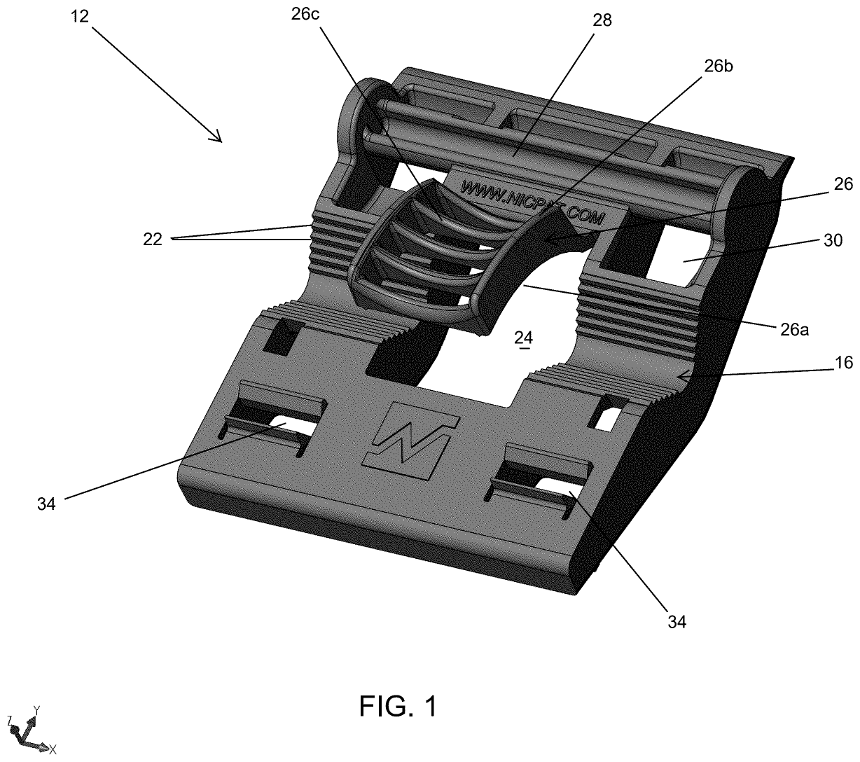

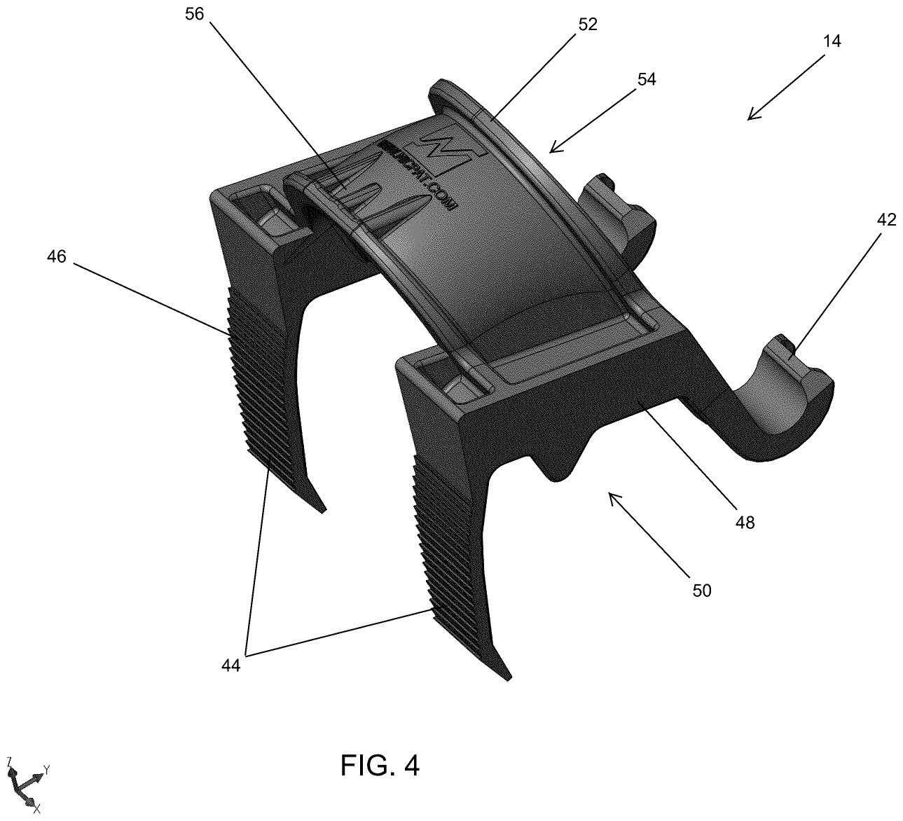

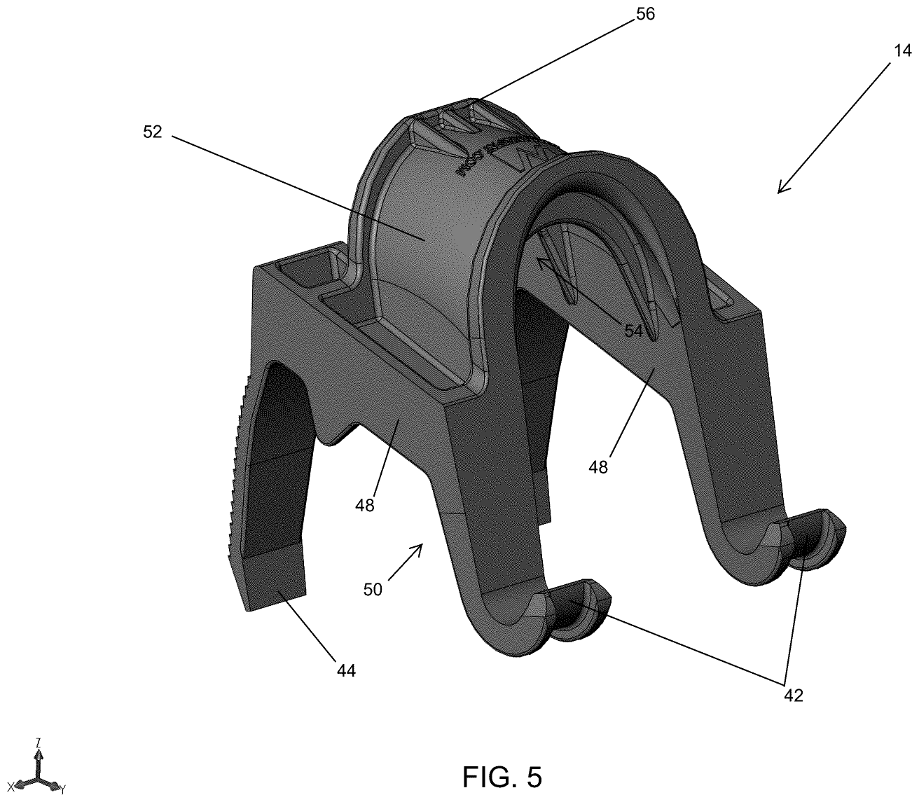

The drop hose clamp 10 according to the described embodiments secures a drop hose to a truss rod in a center pivot irrigation system. The drop hose clamp 10 includes a truss rod connector 12 (FIGS. 1-3) and a securing connector 14 (FIGS. 4 and 5). In some embodiments, the truss rod connector 12 and the securing connector 14 are molded from plastic but may alternatively be constructed using different processes or materials.

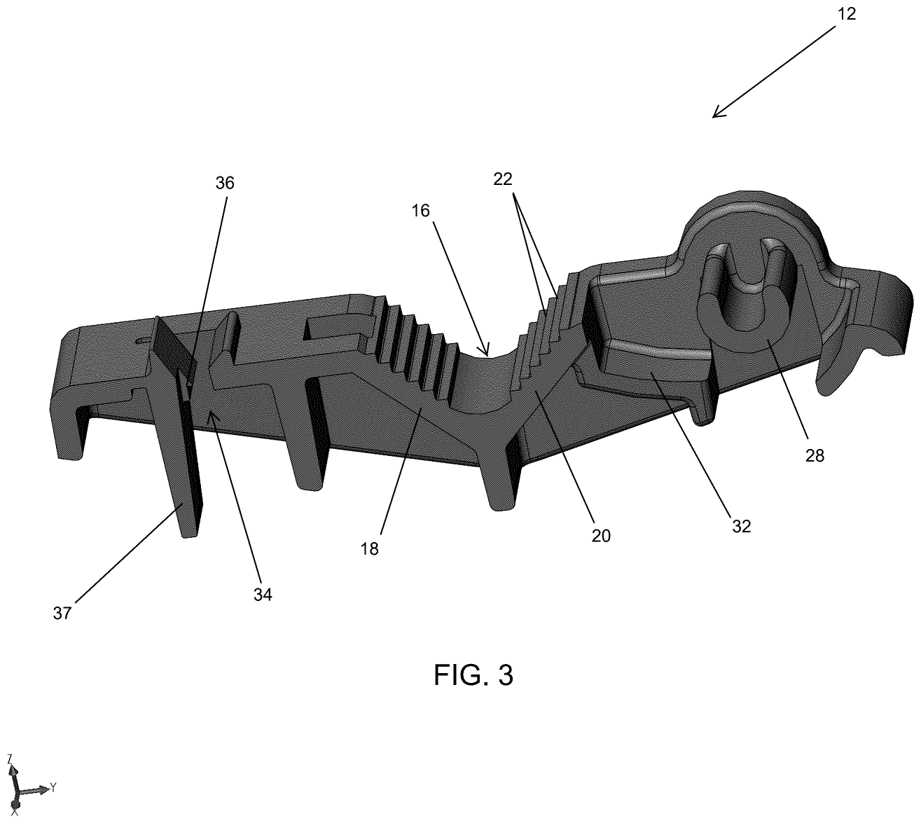

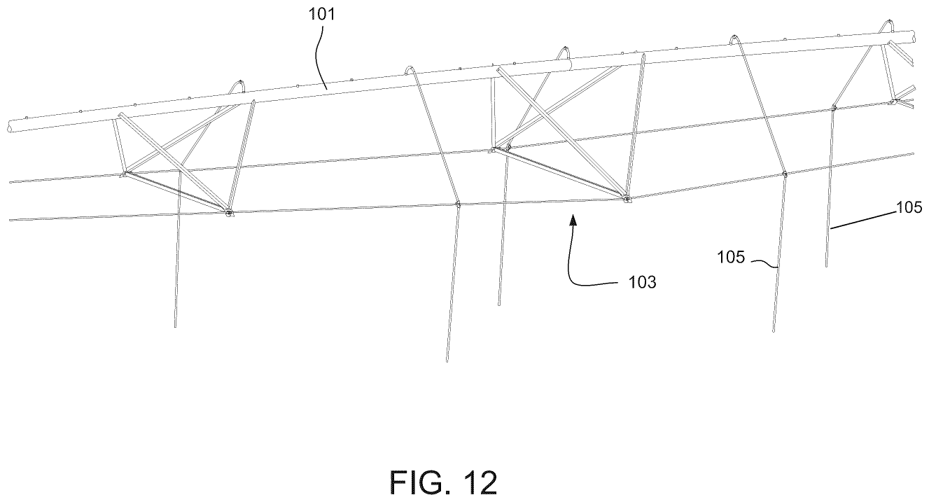

The truss rod connector 12 includes a rod channel 16 that receives the truss rod (e.g., truss rod 103 in FIG. 12). As shown in the side-sectional view of FIG. 3, the rod channel 16 is essentially V-shaped including a first inclined side 18 and a second inclined side 20. Inside surfaces of the channel 16 may be provided with ridges 22 that serve to better secure and engage the truss rod. The truss rod connector 12 may be provided with a central opening 24 (FIG. 1).

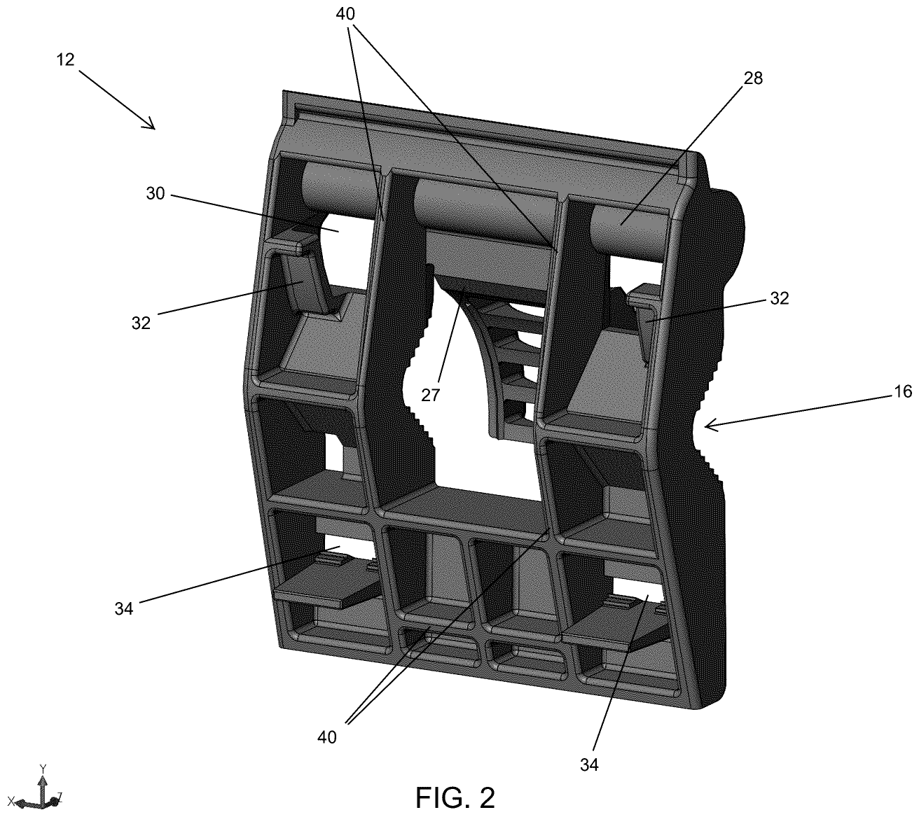

A drop hose wear guard 26 is positioned above the rod channel 16, essentially above the central opening 24. The drop hose wear guard 26 is fixed to a side of the central opening 24. In some embodiments, the drop hose wear guard 26 is slightly manually displaceable away from the central opening 24 via a living hinge 27 or the like (FIG. 2). An underside 26a of the drop hose wear guard 26 may be curved to better accommodate and engage a truss rod in the rod channel 16. A top surface 26b of the drop hose wear guard 26 may similarly be correspondingly curved to better receive a drop hose. An inside surface 26c on the top of the drop hose wear guard 26 may be curved to accommodate the circumference of the drop hose. As shown, the drop hose wear guard 26 may be formed in a ladder configuration to minimize material and reduce the weight of the truss rod connector 12.

A connecting axle 28 extends across the width of the truss rod connector 12 and is positioned on one side of the rod channel 16. The connecting axle 28 may be provided with a rounded exterior axle surface as shown (FIG. 2). With particular reference to FIG. 3, the rounded exterior axle surface of the connecting axle 28 may span an arc less than 360 degrees.

The truss rod connector 12 may also be provided with a pair of pivot arm openings 30 on opposite sides of the drop hose wear guard 26 adjacent the connecting axle 28. A tab member 32 defining a guide surface may be disposed in each of the openings 30.

The truss rod connector 12 includes a pair of ratchet channels 34 disposed on a side of the rod channel 16 opposite from the connecting axle 28. A barb or pawl 36 extends into the ratchet channels 34. In some embodiments, a second barb or pawl sits below barb or pawl 36. The second barb or pawl will engage/kick with the ratchet arms 44 when the hose 105 is pulled away from the truss rod 103. With reference to FIG. 3, in some embodiments, the truss rod connector 12 may include a finger tab 37 below the barb or pawl 36 to enable the ratcheting mechanism to be released by hand.

With reference to FIG. 2, a backside of the truss rod connector 12 may be assembled with a framework 40 including ridges and cross members to increase structural rigidity.

With reference to FIGS. 4 and 5, the securing connector 14 includes a pair of pivot arms 42 engageable with the connecting axle 28. Distal ends of the pivot arms 42 are curved corresponding to the rounded exterior axle surface of the connecting axle 28. The securing connector 14 also includes a pair of ratchet arms 44 respectively engageable with the ratchet channels 34. The ratchet arms 44 include teeth 46 that engage the barb or pawl 36 in the ratchet channels 34 as the ratchet arms 44 are inserted through the ratchet channels 34.

Each of the pivot arms 42 is connected via a bridge 48 to each of the ratchet arms 44. The pivot arms 42, bridges 48 and ratchet arms 44 define a lower channel 50 for receiving the truss rod 103.

A connecting arch 52 serves to connect the pivot arm 42 and ratchet arm 44 on one side of the securing connector 14 with the pivot arm 42 and ratchet arm 44 on an opposite side of the securing connector 14. The arch 52 defines an upper channel or drop hose channel 54 for the drop hose.

The securing connector 14 may be provided with a tool ledge 56 defined by ridges or the like on the connecting arch 52.

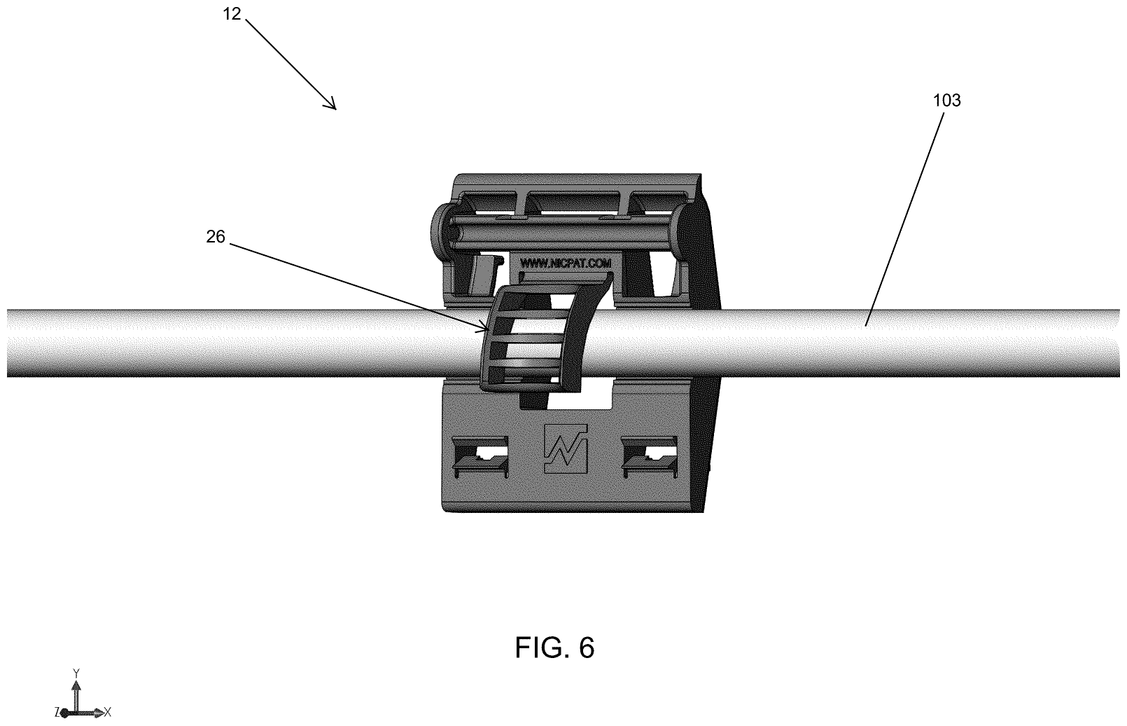

FIGS. 6-10 show the process for securing the drop hose clamp 10 to the truss rod 103 and the drop hose 105. With reference to FIG. 6, the truss rod 103 may be rigidly grabbed by the installer, and the truss rod connector 12 can be positioned on the truss rod 103 with the truss rod 103 in the rod channel 16 and the drop hose wear guard 26 positioned over the truss rod 103. The drop hose wear guard 26 can be manually displaced so that the truss rod 103 can fit in the space between the drop hose wear guard 26 and the rod channel 16. The resiliency of the drop hose wear guard 26 provides an initial connection for the truss rod connector 12 to the truss rod 103.

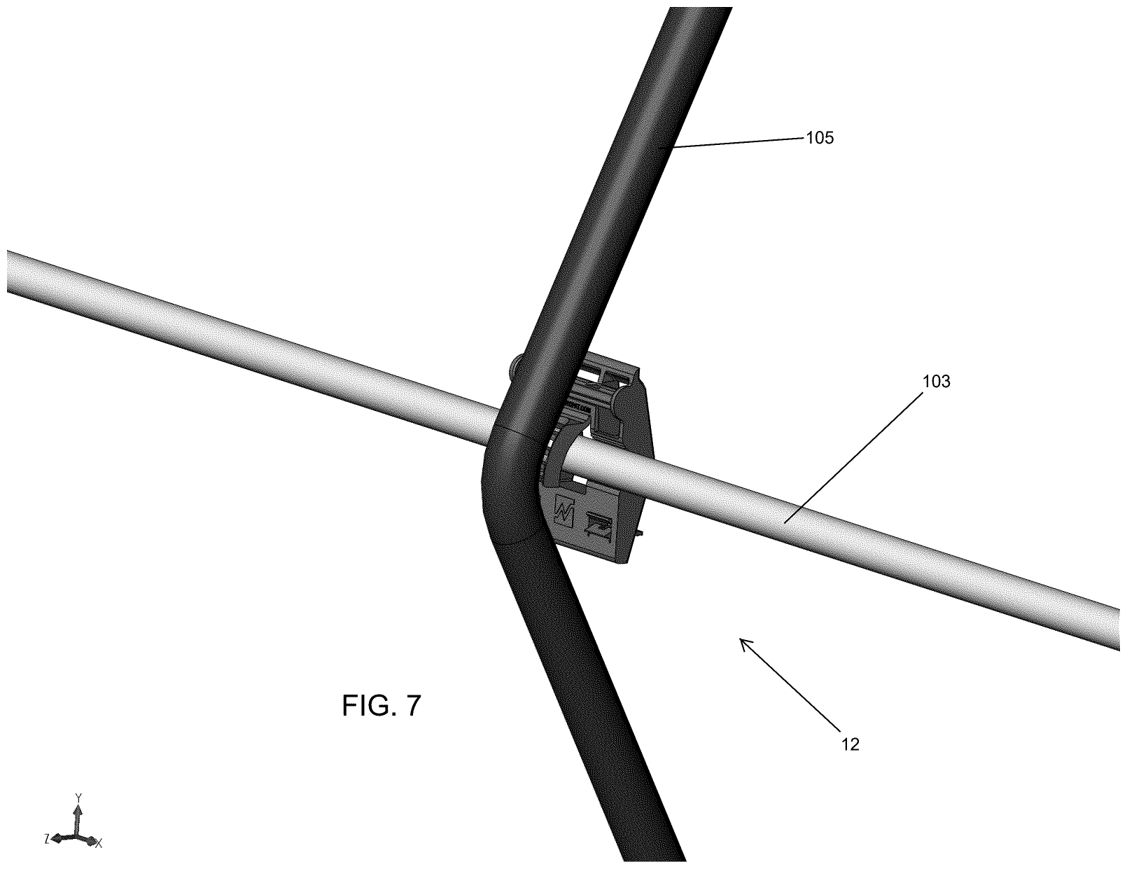

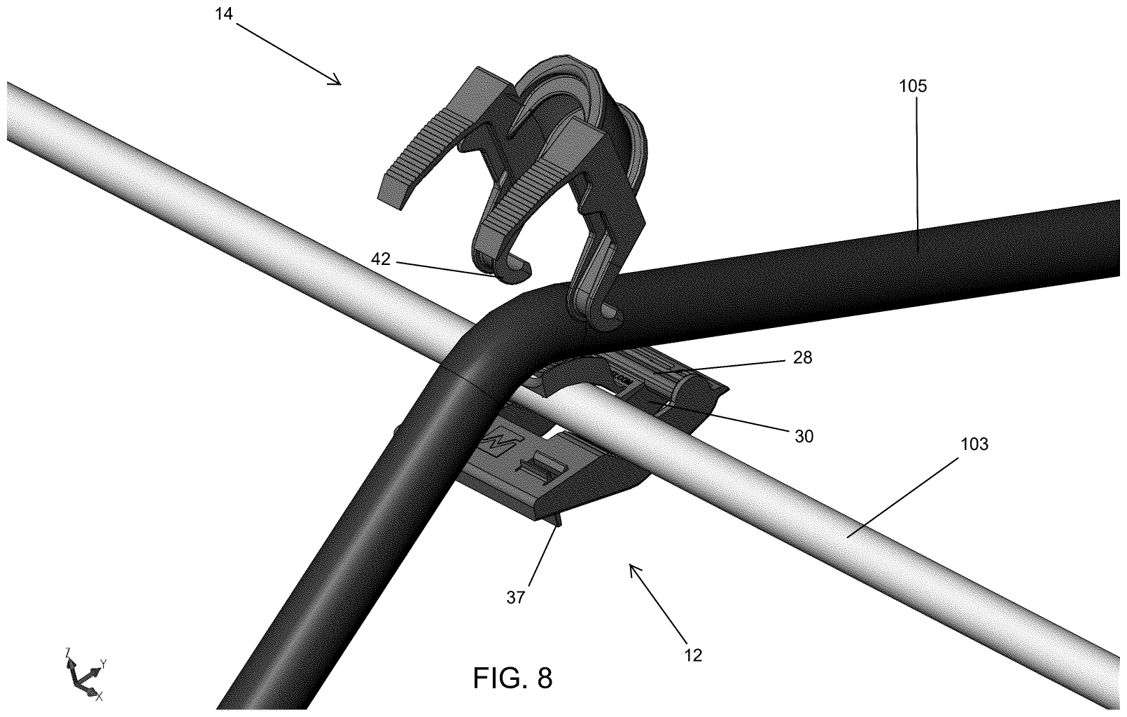

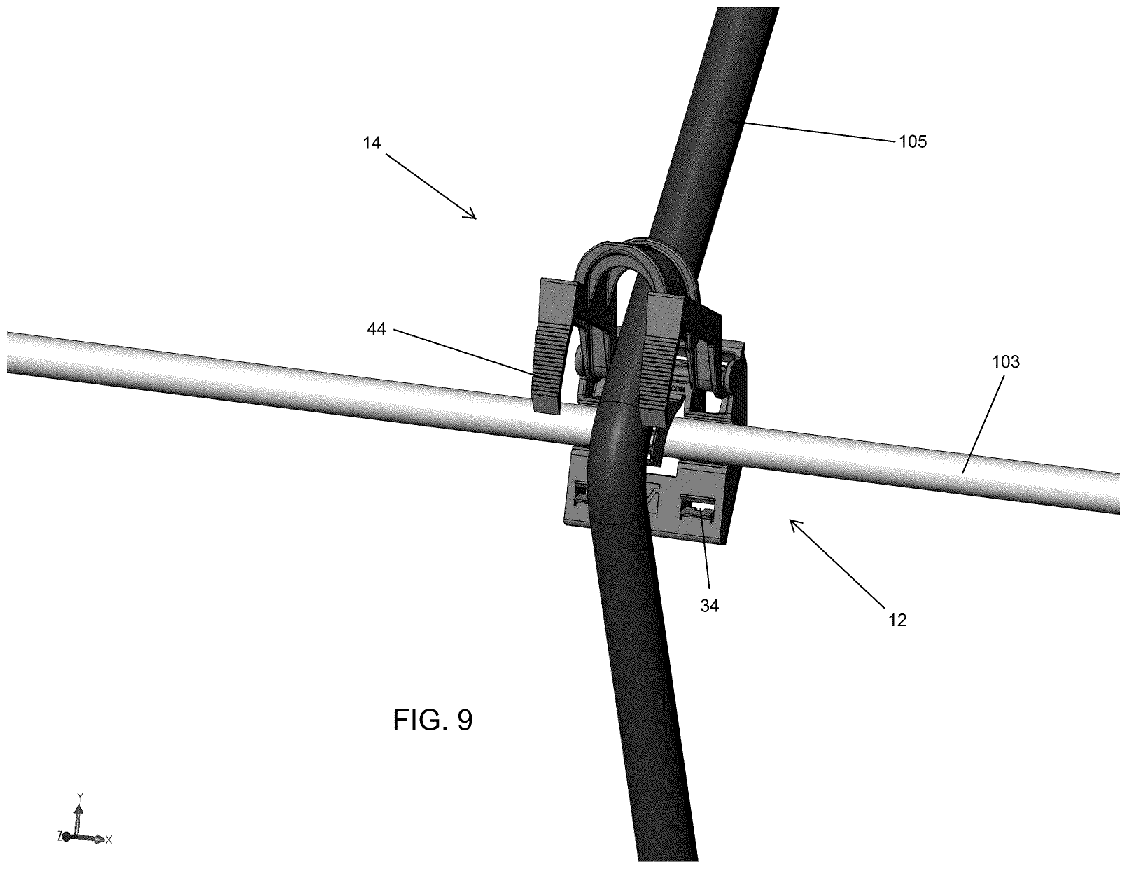

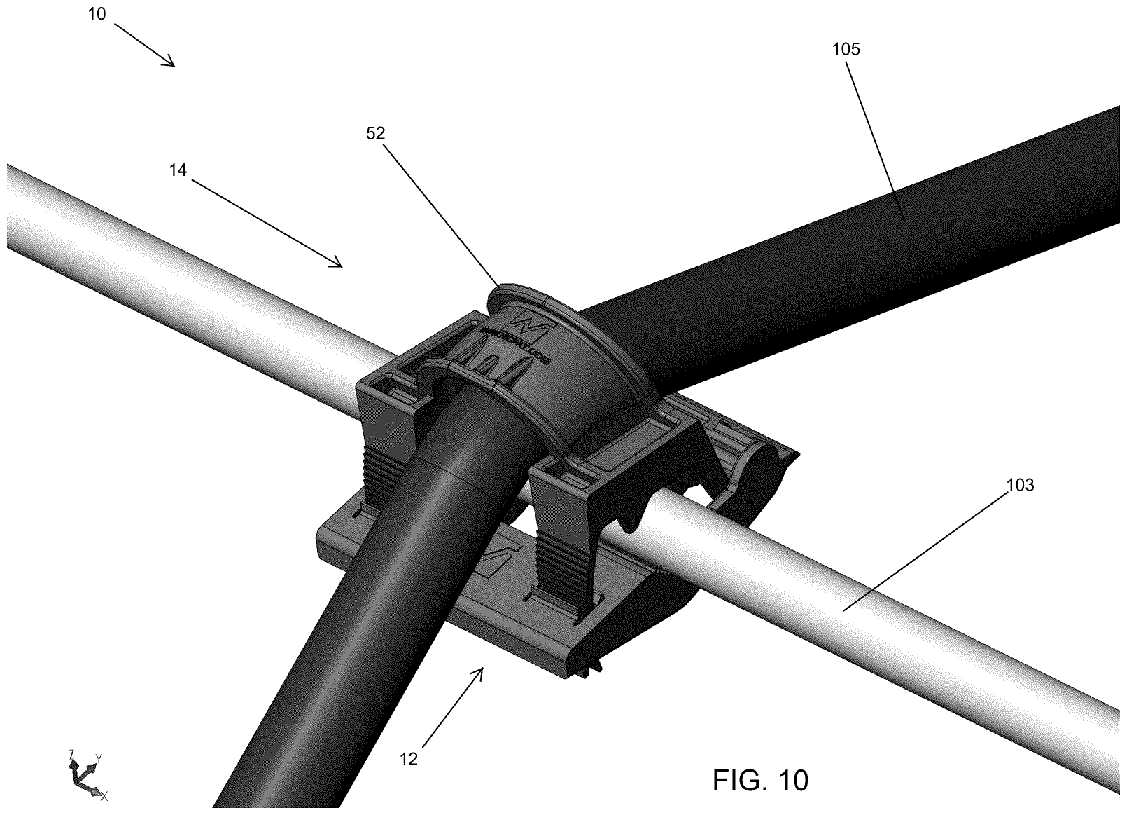

With reference to FIG. 7, the drop hose 105 can then be manually set over the drop hose wear guard 26 in the curved interior surface 26c. With reference to FIGS. 8 and 9, the securing connector 14 is positioned for engagement with the truss rod connector 12. The pivot arms 42 are inserted through the openings 30 into engagement with the connecting axle 28. The tab members 32 guide the pivot arms 42 around the connecting axle 28, and the securing connector 14 is pivoted (counterclockwise in FIG. 9) to insert the ratchet arms 44 into the ratchet channels 34. The teeth 46 on the ratchet arms 44 engage the barb or pawl 36 in the ratchet channels 34 until the truss rod 103 is secured in the lower channel 50, and the drop hose 105 is secured in the upper channel 54. The installer can use a tool to engage the tool ledge 56 or framework 40 to provide a secure connection between the truss rod connector 12 and the securing connector 14. The fully assembled drop hose clamp 10 is shown in FIG. 10.

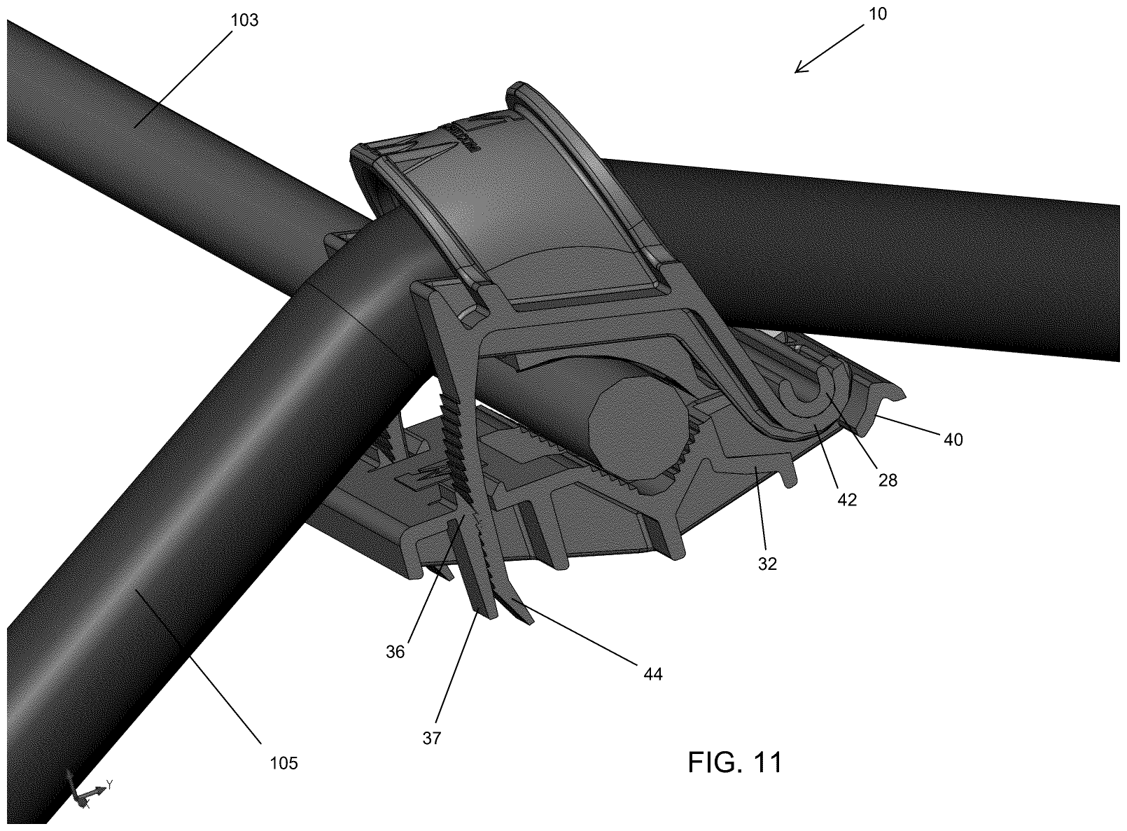

FIG. 11 is a sectional view of the drop hose clamp 10 in the assembled configuration. The arms 42 are secured between the connecting axle 28 and the framework 40, and the ratchet arms 44 are secured in the ratchet channels 34. The connecting arch 52 is seated firmly over the drop hose 105, and the lower channel 50 is fit over the truss rod 103. If needed, the securing connector 14 can be released from the truss rod connector 12 by inserting a flat tool between the barbs or pawls 36 and the ratchet arms 44. In some embodiments, the securing connector 14 can be released by hand displacing the finger tabs 37 so that the pawl 36 disengages from the ratchet arms 44.

The drop hose clamp of the described embodiments secures the drop hose to the truss rod and prevents wear on the drop hose and the span pipe. Distances between the drop hoses can be fixed, and the hoses can be prevented from tangling in the wind. The bracket also prevents the hoses from kinking and is readily reusable. The size of the ratchet arms enables the clamp to accommodate multiple hose sizes (i.e., conventionally, two hose sizes) and multiple truss rod sizes (i.e., conventionally five truss rod sizes).

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A drop hose clamp for securing a drop hose to a truss rod in a center pivot irrigation system, the drop hose clamp comprising:
a truss rod connector including a rod channel that is configured to receive the truss rod, a drop hose wear guard positioned above the rod channel, a connecting axle on one side of the rod channel, and ratchet channels on an opposite side of the rod channel; and
a securing connector engageable with the truss rod connector, the securing connector including pivot arms engageable with the connecting axle, a drop hose channel, and ratchet arms respectively engageable with the ratchet channels.

2. A drop hose clamp according to claim 1, wherein the rod channel comprises ridges.

3. A drop hose clamp according to claim 1, wherein the rod channel is V-shaped.

4. A drop hose clamp according to claim 1, wherein the drop hose wear guard includes a curved lower surface that is shaped to engage the truss rod.

5. A drop hose clamp according to claim 1, wherein the drop hose wear guard defines a channel in an upper surface that is shaped to receive the drop hose.

6. A drop hose clamp according to claim 1, wherein the drop hose wear guard is configured to be manually displaceable away from the rod channel.

7. A drop hose clamp according to claim 6, wherein the drop hose wear guard is connected to the truss rod connector via a living hinge.

8. A drop hose clamp according to claim 1, wherein the truss rod connector further comprises a tool ledge positioned between the ratchet arms.

9. A drop hose clamp according to claim 1, wherein when the securing connector is coupled with the truss rod connector, the drop hose is sandwiched between the drop hose channel and the drop hose wear guard.

10. A drop hose clamp according to claim 1, wherein the ratchet channels comprise a pawl that is configured to engage the ratchet arms.

11. A drop hose clamp according to claim 10, further comprising a finger tab extending from the pawl, wherein the finger tab is configured to enable manual release of the pawl from the ratchet arms.

12. A drop hose clamp according to claim 1, wherein each of the pivot arms is connected via a bridge to each of the ratchet arms, wherein the pivot arms, the bridges, and the ratchet arms define a lower channel for receiving the truss rod.

13. A drop hose clamp according to claim 12, wherein the securing connector further comprises a connecting arch that connects the pivot arm and ratchet arm on one side of the securing connector with the pivot arm and ratchet arm on an opposite side of the securing connector, wherein the connecting arch defines the drop hose channel.

14. A drop hose clamp for securing a drop hose to a truss rod in a center pivot irrigation system, the drop hose clamp comprising:
a truss rod connector including a rod channel and a drop hose wear guard positioned above the rod channel, the truss rod connector including a pivot end and a connecting end; and
a securing connector engageable with the truss rod connector, the securing connector including pivot arms engageable with the pivot end of the truss rod connector, and ratchet arms securable to the connecting end of the truss rod connector.

15. A drop hose clamp according to claim 14, wherein the truss rod connector further comprises a connecting axle on the pivot end and ratchet channels on the connecting end, and wherein the pivot arms are engageable with the connecting axle and the ratchet arms are securable in the ratchet channels.

16. A drop hose clamp according to claim 15, wherein the ratchet arms comprise teeth and the ratchet channels comprise a pawl such that the teeth engage the pawl in the ratchet channels until the truss rod is secured in a lower channel defined by the pivot arms.

17. A drop hose clamp according to claim 16, further comprising a connecting arch that connects the pivot arm and the ratchet arm on one side of the securing connector with the pivot arm and the ratchet arm on an opposite side of the securing connector, wherein the drop hose is securable in an upper channel defined by the connecting arch.

18. A drop hose clamp according to claim 16, further comprising a finger tab extending from the pawl, wherein the finger tab is configured to enable manual release of the pawl from the ratchet arms.

19. A method of securing a drop hose to a truss rod in a center pivot irrigation system with a drop hose clamp, the drop hose clamp including a truss rod connector with a rod channel that is configured to receive the truss rod, a drop hose wear guard positioned above the rod channel, a connecting axle on one side of the rod channel, and ratchet channels on an opposite side of the rod channel, and a securing connector engageable with the truss rod connector including pivot arms engageable with the connecting axle, a drop hose channel, and ratchet arms respectively engageable with the ratchet channels, the method comprising:
(a) positioning the truss rod connector on the truss rod with the truss rod in the rod channel and the drop hose wear guard positioned over the truss rod;
(b) setting the drop hose over the drop hose wear guard;
(c) positioning the securing connector for engagement with the truss rod connector;
(d) engaging the pivot arms with the connecting axle; and
(e) pivoting the securing connector to insert the ratchet arms into the ratchet channels until the truss rod and the drop hose are secured under the securing connector.

20. A method according to claim 19, wherein step (a) is practiced by manually displacing the drop hose wear guard so that the truss rod can fit in a space between the drop hose wear guard and the rod channel.
